(19) United States
(12) Patent Application Publication
(10) Pub. No.: US 2010/0288443 A1
(43) Pub. Date: Nov. 18, 2010

(54) Tuckers e.z. all purpose taping tool

(76) Inventor: Richard Earl Tucker, Anaheim, CA (US)

Correspondence Address: Richard E. Tucker, 8161 Lamonte Rd, Anaheim, CA, 92804, US

(21) Appl. No.: 12/317,288

(22) Filed: Mar. 13, 2009

(51) Int. Cl. B32B 37/12; B05C 3/02

(52) U.S. Cl. 156/577

(57) ABSTRACT

The Tucker EZ Taping Tool is a very simple tool for use in taping the joints and corners when installing drywall or sheetrock. The Tucker EZ Taping Tool uses a box or hopper to serve the mud or taping compound rather than similar tools that require the compound to be pumped into a tube. There is also an adjustment to adjust the amount of compound flowing out with the tape. Using the hopper, rather than a tube allows for the compound to be mixed much thicker eliminating the need to return a second time with thicker compound to cover nails. The tool has a built in knife holder, 3½ inches high and 5 inches long fastened onto the back of the tape holder. This allows the workman to have his knife with him for wiping the tape on the joint as well as spotting nails along the joint.

This application is a continuation-in-part of Ser. No. 12/317,288 filed Mar. 13, 2009 To file corrected application paper. Tuckers E Z All Purpose Taping Tool.

### BACKGROUND OF THE INVENTION

This invention relates to taping surface joints on drywall. It will carry the drywall compound, and allow the compound to overflow on the drywall tape that is on top of a wheel. After the tape is applied to the joint of the drywall, The Taper, will be able to wipe the tape with a 6 inch knife, to smooth the tape so it can be coated with compound.

### SUMMARY OF INVENTION

This invention is very simple, and easy, and inexpensive. Most all of the tools for drywall taping with a wheel, is quite expensive to purchase. This tool only weighs 3 to 4 pounds, without the drywall compound in the box, that is provided for the compound. The front panel of the compound box is slanted This is to allow the compound to form a pocket of compound to feed a continuous flow of material, that will fall on top of the drywall tape. as the drywall tape, is being rolled out of the compound box, will have an even flow of the material.

This tool has handles that has been formed in the plastic, on the bottom of the base, where it is very easy to carry. It helps you to control the wheel as you roll it down the drywall joint. The wheel on the tool will crease the tape, when it is placed into a corner.

Ordinarily a person has to take a pan with compound in it , using a 6 inch knife to spread the compound on each side of the corner, then he has to reach for tape, and place the tape by hand, and place it the corner, by creasing the tape with the 6″ knife.

Taping with this tool, is a time saver, and will save the expense of purchasing other tools to complete the job. This tool comes in three parts, the base, the compound holder box, And a tape holder, which has a 6 inch knife compartment. The compound box can be put on the base, or taken off of the base, by using the two side latches for cleaning purposes.

### BRIEF DESCRIPTION OF THE DRAWINGS

FIG. 1 Shows a Side View of the various components of a constructed tool, in accordance with the present invention. These components being illustrated are in relationship to one another.

FIG. 2. Shows an Illustrates the components of FIG. 1. Assemble, from the Top View.

FIG. 3. Shows the End View from the front.

### DETAILED DESCRIPTION OF THE FIRST EMBODIMENT

FIG. 4 The wheel, and the base, and the drywall compound box, shows the various components connected together ready for use.

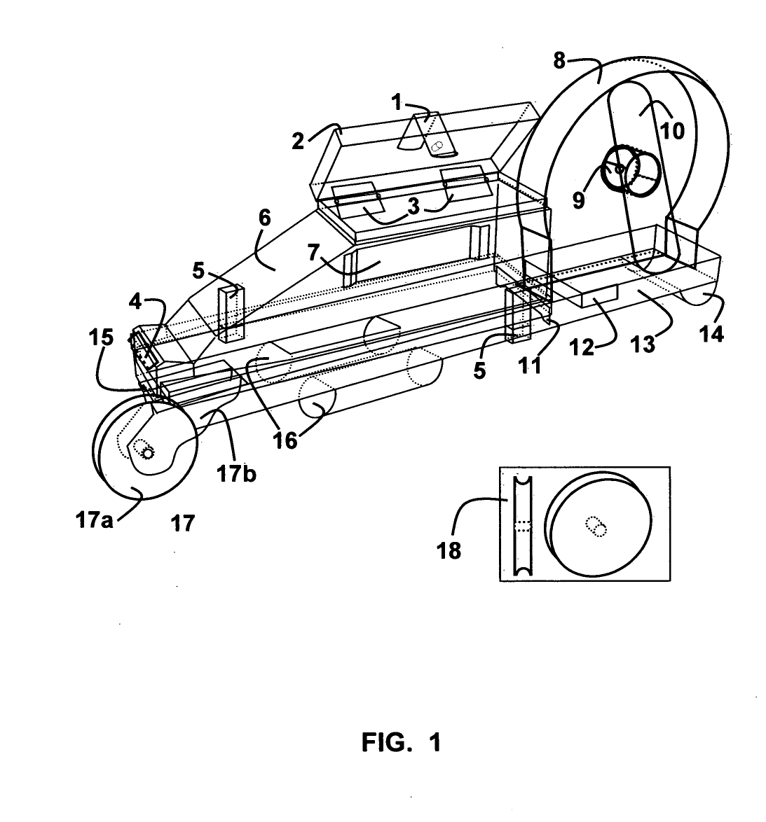

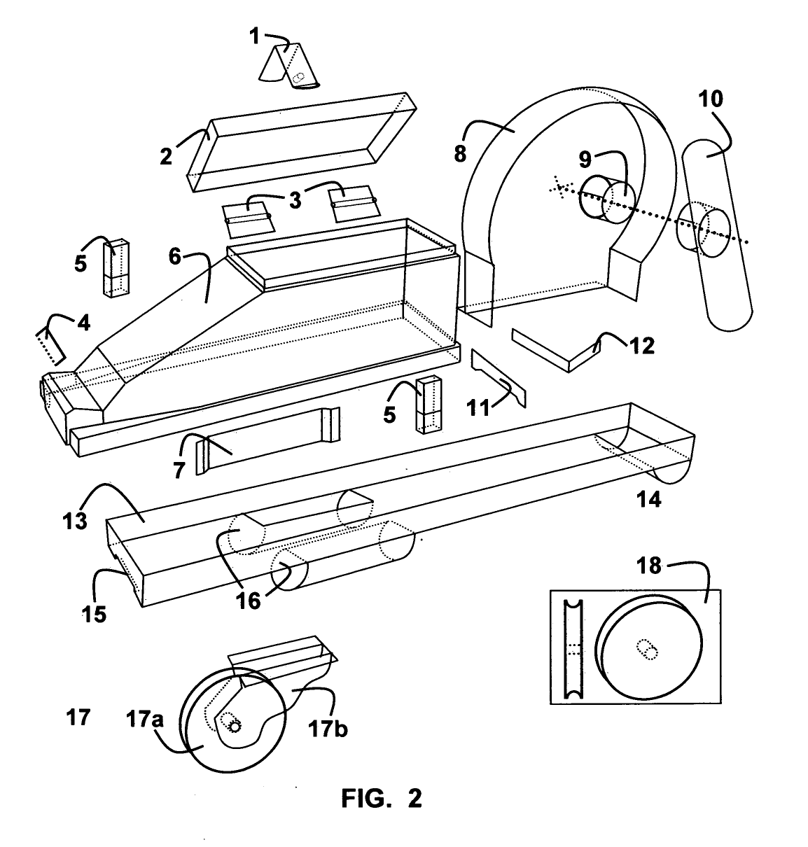

FIG. 1-5 Show the rear handle, and forward handle, on the bottom of the base.

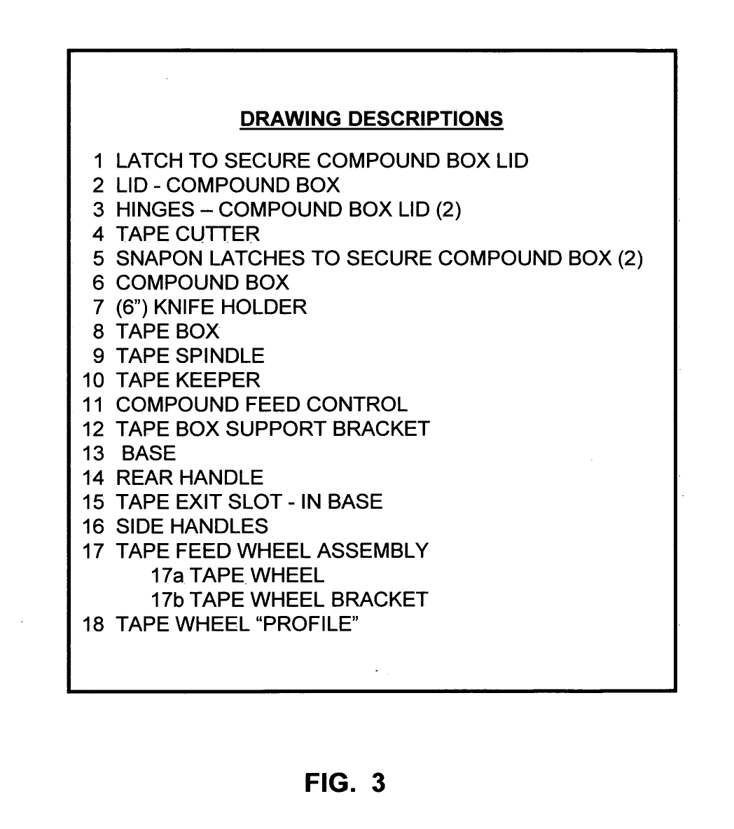

FIG. 3 Show the lid to cover the top.

FIG. 4 Shows the box that holds the drywall compound.

FIG. 6 Shows the tape box which is round, to hold the roll of tape.

FIG. 7 Shows the tape spindle.

FIG. 8 Shows the eight inch plastic screw on, tape keeper.

FIG. 9 Shows the six inch, knife holder.

FIG. 10 Shows the two hinges, for the compound box lid.

FIG. 11 Shows the latch which secures the lid to keep it closed on the compound box.

FIG. 12 Shows the tape cutter assembly.

FIG. 13 Shows the blade to cut the tape,

FIG. 14 Shows adjustment bolts for compound flow.

FIG. 15 Shows compound feed adjuster.

FIG. 16 Shows tape and compound exit.

FIG. 17 Shows the snap on latches to secure the compound box.

FIG. 18 Shows the wheel assembly, to feed the tape as is rolled on to the drywall joint.

1. This tool is called an all purpose tool, because you use the drywall compound thicker, than other drywall tools do. This will allow the Taper too work with the excess compound that comes on his knife, as he is wiping the tape, to be able to coat the tape, or to spot the nails, or coat the metal, at the same time he is wiping the tape. By working with the compound, as you are wiping the tape, will save a lot of time, and expense, because the taper won't have to come back a second time to coat the tape that he had previously taped.

2. The Tool is very light weight, to carry and to handle.

2. It is designed as a hand tool, to have a wheel, that will roll the drywall tape onto the drywall joint.

4. It has a knife compartment on the tape box, so it will be at ones reach, when he needs to wipe the tape.

5. The blade is above the wheel to cut the tape, when you reach the end of the joint.

6. It has a lid on top of the compound box, which opens with two hinges, and a closing latch.

7. This tool can be made out of Plastic, or Aluminum, which makes it light weight.
